(19) United States
(12) Patent Application Publication
(10) Pub. No.: US 2026/0225057 A1
(43) Pub. Date: Aug. 6, 2026

(54) APPARATUS AND METHOD FOR PRODUCTION OF SYNGAS

(71) Applicant: Council of Scientific and Industrial Research, New Delhi (IN)

(72) Inventors: Radhamonyammma Nandini DEVI, Pune (IN); Akshay Ramnath KASAR, Pune (IN); Vipul Subhash PATIL, Pune (IN); Shubham Ramvilas KATRE, Pune (IN)

(73) Assignee: Council of Scientific and Industrial Research, New Delhi (IN)

(21) Appl. No.: 19/152,484

(22) PCT Filed: Jan. 31, 2024
(86) PCT No.: PCT/IN2024/050088

§ 371 Date: Jul. 31, 2025

(30) Foreign Application Priority Data
Jan. 31, 2023 (IN) 202311006414

(51) Int. Cl. B01J 8/04; C01B 3/38

(52) U.S. Cl. CPC B01J 8/0453; C01B 3/38; B01J 2208/00849; B01J 2208/00902; C01B 2203/0238; C01B 2203/0283; C01B 2203/1011; C01B 2203/1241

(57) ABSTRACT

The present disclosure provides an apparatus for production of syngas. In the apparatus, the spinning flow will be creating an entirely different velocity and flow profile inside the reactor which is further helping for good heat distribution, optimum heat utilization as well as gas mixing. This will reduce the coke formation issues due to cracking and hydrogenation reactions. Further, favourable heat distribution may be helpful to avoid catalyst sintering and/or its deactivation due to sintering. Boudouard reaction may further create a lot of deactivation issues due to the carbon formation. As the reaction is exothermic, coke formation is favoured in the apparatus (100) where temperature is in the range of 500-700 degree Celsius. In order to avoid the problem, a temperature quenching zone is provided within the apparatus (IO0) where direct water is quenched into the apparatus (IO0), thereby allowing for sudden temperature drop as well as coke gasification.

### FIELD OF THE INVENTION

The present invention relates to an apparatus for production of syngas. Particularly, the present invention relates to a method of production of syngas by reforming of methane (RM).

### BACKGROUND OF THE INVENTION

Hydrogen gas (H₂) is being considered promising as a potential green fuel and various processes, including steam reforming, carbon dioxide (CO₂) reforming, biomass gasification, coal gasification, etc. have been suggested as techniques for producing hydrogen gas. These processes can also produce syngas, which is a mixture of carbon monoxide and hydrogen (CO+H₂), which is a platform chemical.

Of the above-mentioned processes, dry reforming of methane (CH₄), which uses CO₂ to reform CH₄, is a good option for producing lean syngas, which can be further used for value added chemical synthesis.

However, one of the limitations of this reaction is the formation of carbon due to multiple source reactions and subsequent deactivation of a reaction catalyst. Further, a separate water gas shift stage may also usually be required to enhance the hydrogen production. Furthermore, the process also faces problems associated with poor heat distribution, hot spot formation, cracking, carbon formation, reactor chocking, syn gas quality optimization, scale up limitations, etc.

References may be made to patent application No. US2015136047A1, which discloses a fuel reformer, which is directly coupled into exhaust gas pipe to use exhaust energy, composed of: (i) a reformer shell to hold the catalyst reactor core; (ii) at least one fin to absorb exhaust energy from the exhaust gas and to heat the catalyst reactor core; (iii) a fuel injector, which introduces fuel into the fuel reformer and (iv) a swirl generator, which promotes homogeneous mixing between exhaust gas and fuel wherein the fuel being injected into the reformer is methane which reacts with carbon dioxide in exhaust loop to form syngas through dry reforming process. However, according to this reformer and process thereof, there is very high chance of formation of coke considering methane and CO2 are used without steam.

References may be made to patent application No. WO1998049097A1, which reports fluidized bed apparatus for the partial oxidation and steam reforming of light hydrocarbon gas such as methane to convert such a gas to synthesis gas. However, it is submitted that this is an entirely different reaction than dry reforming of methane. In said partial oxidation reaction, the coke formation is minimized due to the presence of O₂, and not the water or steam.

There is, therefore, a requirement in the art for a means to produce syngas efficiently by reforming methane that overcomes the limitations listed above.

### OBJECTS OF THE INVENTION

Main object of the present invention is to provide an apparatus for production of syngas.

Another object of the present invention is to provide an apparatus that reduces carbon formation during dry reformation of methane.

Yet another object of the present invention is to provide an apparatus for production of syngas that increases the operating life of catalyst, with improved durability of the catalyst.

Yet another object of the present invention is to provide an apparatus with improved operational parameters for efficient production of syngas.

Yet another objective of the present invention is to provide a process to produce the syngas of desired H₂:CO ratio.

### BRIEF DESCRIPTION OF THE DRAWINGS

FIG. 1 illustrates a schematic representation of an apparatus [100] for production of syngas with [106] and without swirl [107].

FIGS. 2A and 2B illustrate exemplary velocity profiles in the apparatuses [201], [202], [207] and [208].

FIG. 3 illustrates exemplary pressure profiles in the apparatuses [301] and [302].

FIG. 4A to 4C illustrate exemplary temperature profiles in the apparatuses [401], [402], [406], [407], [409], and [410].

FIG. 5 illustrates an exemplary plot depicting gas chromatography results.

FIG. 6 illustrates an exemplary plot depicting gas chromatography results.

FIG. 7 illustrates a schematic representation of an apparatus [700] for production of syngas; wherein 700 represents the whole apparatus consisting of parts from 701-710.

### SUMMARY OF THE INVENTION

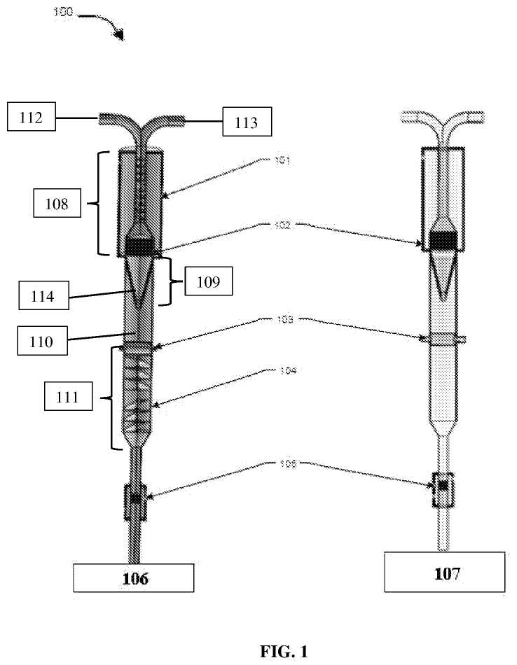

Accordingly, present invention provides an apparatus for reforming of methane (RM), comprising:
i. a reforming zone [108, FIG. 1];
ii. a high velocity zone [109, FIG. 1];
iii. a coke gasification zone [110, FIG. 1];
iv. a water gas shift (WGS) zone [111, FIG. 1]; and
v. one or more spinning flow guider(s) or swirler(s) [101 & 104, FIG. 1].

In an embodiment of the present invention, the reforming zone [108, FIG. 1] being an upper part of the apparatus comprises: i) a first catalyst bed [102, FIG. 1], and ii) tangential inlet pipes [112 & 113, FIG. 1] for methane gas and CO₂ gas.

In another embodiment of the present invention, the high velocity zone [109, FIG. 1] comprises a nozzle shaped device [114, FIG. 1] for increasing back pressure and good heat transfer.

In yet another embodiment of the present invention, the coke gasification zone [110, FIG. 1] comprises inlet for water [103, FIG. 1] to react with coke, carbon or graphite.

In yet another embodiment of the present invention, the WGS zone [111, FIG. 1] comprises: i) a second catalyst bed [105, FIG. 1], and ii) unreacted water.

In yet another embodiment of the present invention, the one or more spinning flow guider or swirlers [101 & 104, FIG. 1] is/are disposed above the first catalyst bed [102, FIG. 1] in the reforming zone [108, FIG. 1] and below the coke gasification zone [110, FIG. 1] for turbulent mixing, achieving heat distribution and heat transfer, and reducing coke formation in overall reactor.

In yet another embodiment of the present invention, the nozzle shaped device [114, FIG. 1] of the high velocity zone [109, FIG. 1] is fabricated after the catalytic bed [102, FIG. 1] in order to maintain high fluid flow velocity, which helps to create the desired back pressure in the catalyst bed and avoid channeling.

In yet another embodiment of the present invention, the high velocity zone [109, FIG. 1] creates a low-pressure zone near a tip of the nozzle shaped device [114, FIG. 1], which assists in water—gas mixing and carbon gasification.

In yet another embodiment of the present invention, the WSG zone, the unreacted water from the coke gasification zone [110, FIG. 1] is used for water-gas shift reaction, maintaining the desired syngas production as in H₂:CO gases mixture.

In yet another embodiment, present invention provides a method of production of syngas by reforming of methane (RM), comprises:
a) passing a methane gas and CO₂ gas from tangential inlet pipes [112 & 113, FIG. 1] placed in the reforming zone [108, FIG. 1] being an upper part of the apparatus as claimed in claim 1, through spinning flow guider(s) or swirler(s) [101 & 104, FIG. 1] to have better turbulent mixing to the catalyst bed of the reforming zone to obtain syngas (CO+H₂);
b) passing the syngas of step a) through conical/nozzle shaped device of the high velocity zone [109, FIG. 1] with turbulent flow where a flow velocity increases, pressure decreases and better mixing with water from water inlet;
c) passing the mixture of syngas, and other unreacted gases of step b) through coke gasification zone [110, FIG. 1] where the coke/carbon deposits is reduced by reacting with water thereby gasifying the coke; and
d) passing an unreacted water in the WGS zone [111, FIG. 1] in order to obtain H₂ and CO gases.

In yet another embodiment, present invention provides a method of production of syngas by reforming of methane (RM), comprises:
i. before passing of the methane gas and CO₂ gas in the apparatus, the reforming zone [108, FIG. 1] is heated with a ramp rate of 10° C./min till temperature reached to 850° C.; and
ii. after passing the methane gas and CO₂ gas in the apparatus, water is injected with a flow rate of 0.1 to 1 ml/min through water entry provided below the first catalyst bed [102, FIG. 1] where reaction of the methane gas and CO₂ gas in presence of said first catalyst bed (102) is performed at temperature in the range of 700-1000° C. to obtain H2 and CO as outlet gases.

In yet another embodiment of the present invention, conversion of CH₄ and CO₂ into CO and H₂ is in the range of 90-95%; and yield ratio of H₂:CO ratio is in the range of 1-1.5.

In yet another embodiment of the present invention, temperature of the steps b), c) and d) is in the range of 250-1000° C.

In yet another embodiment of the present invention, the reforming of methane is selected from the group consisting of dry reforming of methane (DRM), steam reforming of methane (SRM), oxidative steam reforming of methane (OSRM), methanol reforming and ethanol reforming.

### DETAILED DESCRIPTION OF THE INVENTION

Hydrogen gas (H₂) is being considered promising as a potential green fuel and various processes, including steam reforming, carbon dioxide (CO₂) reforming, biomass gasification, coal gasification, etc. have been suggested as techniques for producing hydrogen gas. These processes can also produce syngas, which is a mixture of carbon monoxide and hydrogen (CO+H₂), which is a platform chemical. Of the above-mentioned processes, dry reforming of methane (CH₄), which uses CO₂ to reform CH₄, is a good option for producing lean syngas, which can be further used for value added chemical synthesis.

However, one of the limitations of this reaction is the formation of carbon due to multiple source reactions and subsequent deactivation of a reaction catalyst. Further, a separate water gas shift stage may also usually be required to enhance the hydrogen production. Furthermore, the process also faces problems associated with poor heat distribution, hot spot formation, cracking, carbon formation, reactor chocking, syn gas quality optimization, scale up limitations, etc. In some cases, carbon formation may be due to cracking and in-situ hydrogenation, which in turn, may be due to the poor heat distribution and hot spot formation. In order to avoid this problem, the present disclosure provides an apparatus for dry formation of methane where the fluid flow profile in the apparatus will not be linear, and it will be a spinning flow orbiting the apparatus cross-sectional area.

In conventional reactors, no swirlers are reported. Further, conventionally, different zones are not provided for production of syngas and reformation of methane with lower coke production and better heat transfer. Further, in convention reactors, steam is used as a reforming reaction reactant, however, in present case water is used which will help for restricting the carbon formation reactions by making them thermodynamically unfavourable. The water also helps to gasify the formed coke furthermore it is being used for water gas shift reaction to improve/optimize the quality of Syn Gas which is economically efficient.

The present invention provides an apparatus for production of syngas. In particular, the present disclosure relates to an apparatus for producing syngas by reforming of methane.

The terms “apparatus” or “reactor” are used interchangeably, with somewhat similar/same meaning for production of syngas.

The apparatus is made of a material including iron, such as stainless steel and other alloys including nickel, chromium, aluminium, etc.

The apparatuses 106, 201, 207, 301, 401, 406, and 409 are with swirlers (at least two swirlers' zones), and the apparatuses 107, 202, 208, 302, 402, 407 and 410 are without swirlers.

The apparatus may include a reforming zone [108, FIG. 1]; a high velocity zone [109, FIG. 1]; a coke gasification zone [110, FIG. 1]; a water gas shift (WGS) zone [111, FIG. 1]; and one or more spinning flow guider(s) or swirler(s) [101 & 104, FIG. 1].

The reforming zone [108, FIG. 1] being an upper part of the apparatus comprises: i) a first catalyst bed [102, FIG. 1], and ii) tangential inlet pipes [112 & 113, FIG. 1] for methane gas and CO₂ gas.

The high velocity zone [109, FIG. 1] may include a nozzle shaped device [114, FIG. 1] for increasing back pressure and good heat transfer.

The coke gasification zone [110, FIG. 1] may include inlet for water [103, FIG. 1] to react with coke, carbon or graphite;

The WGS zone [111, FIG. 1] may include a second catalyst bed [105, FIG. 1], and unreacted water to further get better quality syngas.

The one or more spinning flow guider or swirlers [101 & 104, FIG. 1] is/are disposed above the first catalyst bed [102, FIG. 1] in the reforming zone [108, FIG. 1] and below the coke gasification zone [110, FIG. 1] for turbulent mixing for better mixing, achieving heat distribution and heat transfer, and reducing coke formation in overall reactor.

The present invention further provides a method of production of high-quality syngas products using the apparatus. The method may include passing methane gas and CO₂ gas from two separate pipes from above portion of the reactor through spinning flow guider (swirlers) to have better turbulent mixing to a catalyst bed to obtain syngas (CO+H₂). The method may further include passing the obtained syngas through conical/nozzle shaped device with turbulent flow where further flow velocity increases, pressure decreases and better mixing with water from water inlet. The method may further includes passing the mixture of syngas, and other unreacted gases through gasification zone where formed coke/carbon deposits is reduced by reacting with water to gasify the coke. The method may further include using unreacted water in WGS zone to maintain desired quality of H₂:CO ratio.

FIG. 1 illustrates a schematic representation of an apparatus [100] for production of syngas. The apparatus [100] includes a reforming zone [108], a high velocity zone [109], a coke gasification zone [110], a water gas shift (WGS) zone [111] and spinning flow guides [101 & 104].

In the reforming zone, a catalyst for reforming is loaded and apparatus cross-section is about 3 times of an inlet of the apparatus. Such a design allows to maintain desire superficial velocity inside the catalytic bed.

After the catalytic bed, a conical outlet is provided in order to maintain high fluid flow velocity, which helps create desired back pressure in the catalyst bed and avoid channeling. Apart from this, such high velocity region also creates low pressure zone near the tip of the conical section which is helpful for water—gas mixing and carbon gasification.

A separate coke gasification zone is provided where water is used for carbon gasification. The water inlets flows and temperatures are maintained in such a way that heat is quenched and gasification of coke may be achieved. This will help to reduce coke formation during the reaction, thereby improving the reaction throughput. The unreacted water from gasification zone is further used for water gas shift (WGS) reaction in the same apparatus. The water gas shift reaction will help to maintain the desired quality of syn gas from the reactor outlet.

In the apparatus of the present invention, the steam (water) injection is not provided into the fuel or catalyst region, but at the outlet, to bring the temperature below Boudouard reaction hence addressing problem of the coke formation.

Flow guides are also proposed to create the spinning flow regimes inside the apparatus 100. Such flow patterns create turbulent flow inside the apparatus 100, which helps in maintaining a desirable heat distribution and heat transfer inside the apparatus 100.

In an apparatus (100), the essential components recited are:
i. 1^{st} swirlers (101) in the reforming zone and high velocity zone for specific high velocity and flow of liquid;
ii. First catalyst bed (102) in upper region of apparatus (100);
iii. water inlet (103) in gasification zone;
iv. 2^{nd} swirlers (104) in the Water Gas Shift (WGS) zone as spinning flow guides along with second catalyst bed (105).

Moreover, the apparatus [100] differentiates production of syngas process by providing two apparatuses i.e., apparatus with swirlers [106] and apparatus without swirlers [107] wherein swirlers [101] and [104] are present in apparatus [106] and absent in apparatus [107].

In the apparatus [100], the spinning flow will be creating an entirely different velocity and flow profile inside the reactor which is further helping for good heat distribution, optimum heat utilization as well as gas mixing. This will reduce the coke formation issues due to cracking and hydrogenation reactions. Further, favourable heat distribution may be helpful to avoid catalyst sintering and/or its deactivation due to sintering. Boudouard reaction may further create a lot of deactivation issues due to the carbon formation. As the reaction is exothermic, coke formation is favoured in the apparatus [100] where temperature is in the range of 500-700° C. In order to avoid the problem, a temperature quenching zone (or coke gasification zone) is provided within the apparatus [100] where direct water is quenched into the apparatus [100], thereby allowing for sudden temperature drop as well as coke gasification. A customized fluid flow profile is provided for this reaction, which improves the mass and heat transfer to help the H₂ formation reaction. The apparatus [100] further offers an additional flexibility to use quenching water to optimize the H₂:CO ratio by WGS reaction. The cross-section of the apparatus [100] may also be varied according to the vapor densities of reactants and products to maintain the optimum superficial velocities and contact time within the catalyst bed.

The apparatus may provide better H₂ and CO formation and CH₄ reformation with better yield, heat transfer and lesser coke production thereby increasing stability of catalysts.

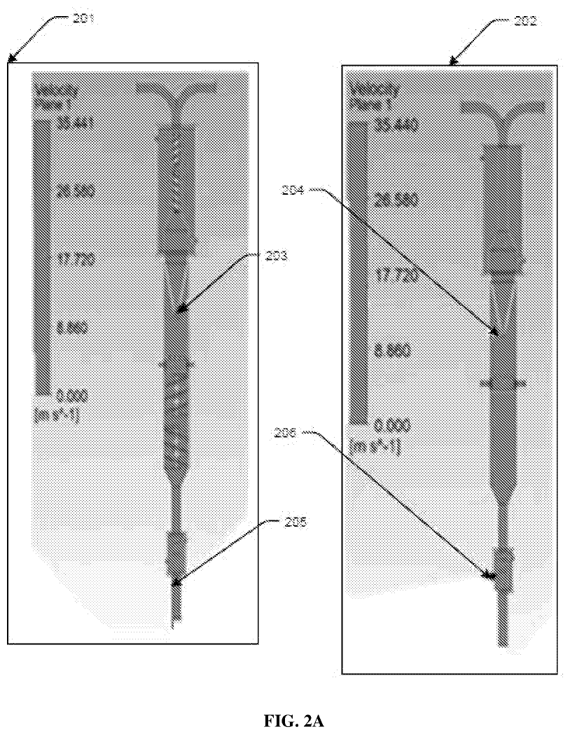

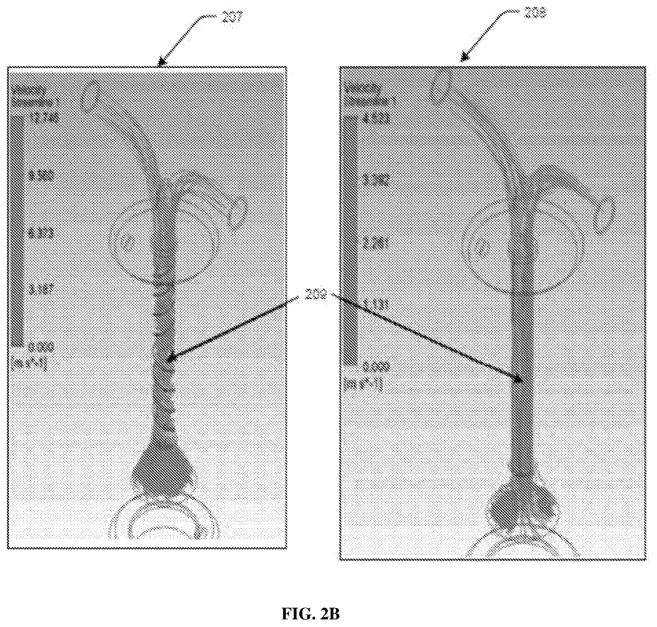

FIGS. 2A and 2B illustrate exemplary velocity profiles in the apparatus. Specifically, FIG. 2A provides two apparatuses [201] and [202] which explain velocity contour of liquid and gas flow. In this regard, the apparatus [201] shows higher velocity at nozzle [203], and at reactor exit [205] due to swirling flows of liquids and gases, which covers said high-velocity zone. In contrast to this, the reactor [202] shows lower velocity at nozzle [204], and at reactor exit [206] due to absence of swirling flow of liquids and gases. More specifically, FIG. 2B showed that the swirling flow has increased the velocity in the top zone [209](preferably in a reforming zone and a high-velocity zone) of apparatus [207] when compared with apparatus [208]. Thus, velocity profiles of the apparatuses show that a highly turbulent flow can be created using spinning flow guiders (swirlers). This type of flow may not be seen in conventional reactors. Further, such turbulent flow offers several advantages as it is improving heat and mass transfer, and it also helps to avoid hot spots by maintaining good heat distribution across the reactor.

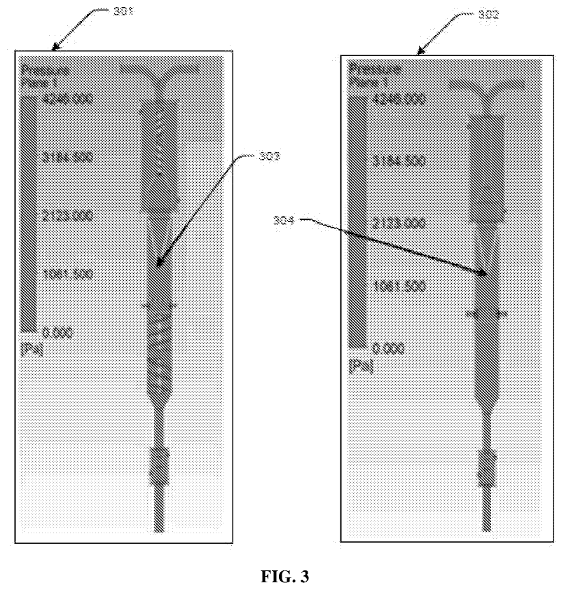

FIG. 3 illustrates exemplary pressure profiles in the apparatus. Specifically, FIG. 3 provides two apparatuses [301] and [302] which explain pressure contour of liquid and gas flow. In this regard, the apparatus 301 shows lower pressure zone near or at nozzle [303] due to swirling flows of liquids and gases. In contrast to this, the reactor 302 shows higher pressure zone at or near nozzle [304]. Accordingly, the pressure profile of the apparatuses shows that a low pressure and high velocity zone is created at the conical outlet/nozzle. This helps for water gas mixing and will avoid Boudouard carbon formation.

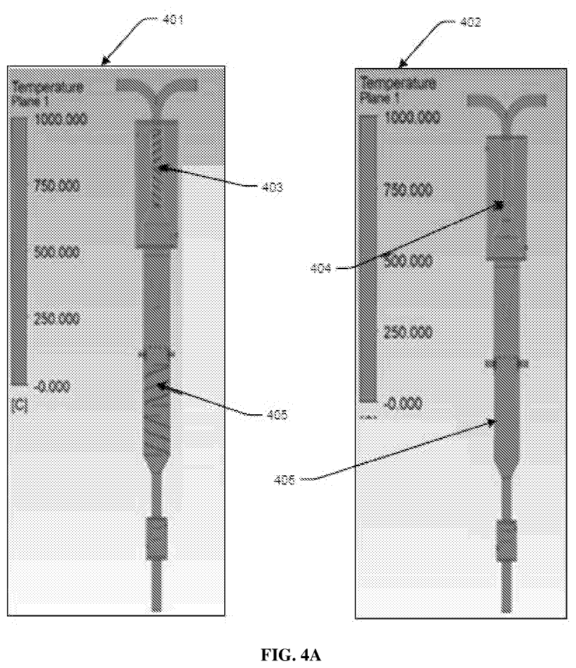

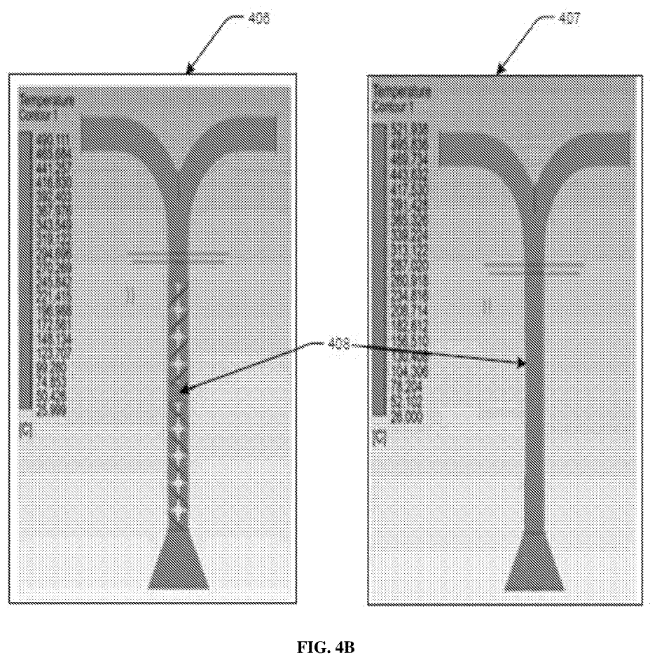

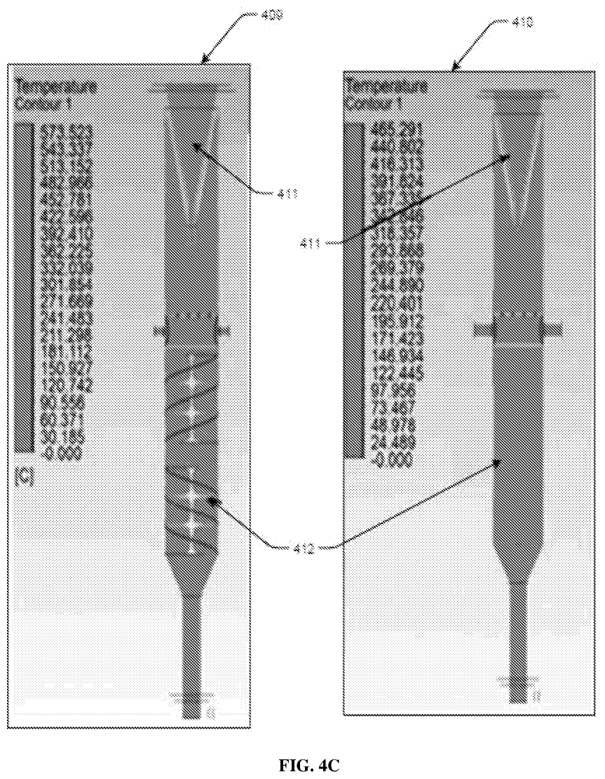

FIG. 4A to 4C illustrate exemplary temperature profiles in the apparatus. Specifically, FIG. 4A provides two apparatuses [401] and [402] which explain temperature contour of liquid and gas flow with and without swirlers [101 and 104]. In this regard, the apparatus [401] shows absorption of temperature (lowering of temperature) in variable quantity by product gases from jacket [403] due to swirling effect, and contrasting to this, temperature is increased near 2^{nd} swirlers [104] in lower zones of apparatus, i.e., variable temperature pattern/range is seen in apparatus having one or more swirlers [405]. In apparatus [402], the temperature behaviour is not that variable and it shows uniform temperature profile [404] without swirlers. Accordingly, referring now to FIG. 4A, the temperature profile of the apparatus shows that due to the proposed design, a desired temperature distribution inside the apparatus may be achieved whereas in conventional reactors, such heat distributions may not be possible.

FIG. 4B shows and confirms that the temperature in the apparatus [406] is more uniform [408] in the overall zone (inside the zone as well as surface/wall) due to presence of swirling flow, as compared to apparatus 407 having maximum temperature range near the wall surface. The same contrasting temperature distribution is seen in FIG. 4C, which explains higher temperature range in upper funnel/conical section [411] and lower funnel/conical section [412] of apparatus 409 due to swirling flow, and in contrast to this, lower temperatures in the apparatus 410. Hence, the temperature profiles clearly indicate that the apparatus [100] will be helpful to avoid cracking, carbon formation reactions and helpful for reforming and WGS reactions, as desirable heat transfer and turbulent flow mixing can be clearly seen.

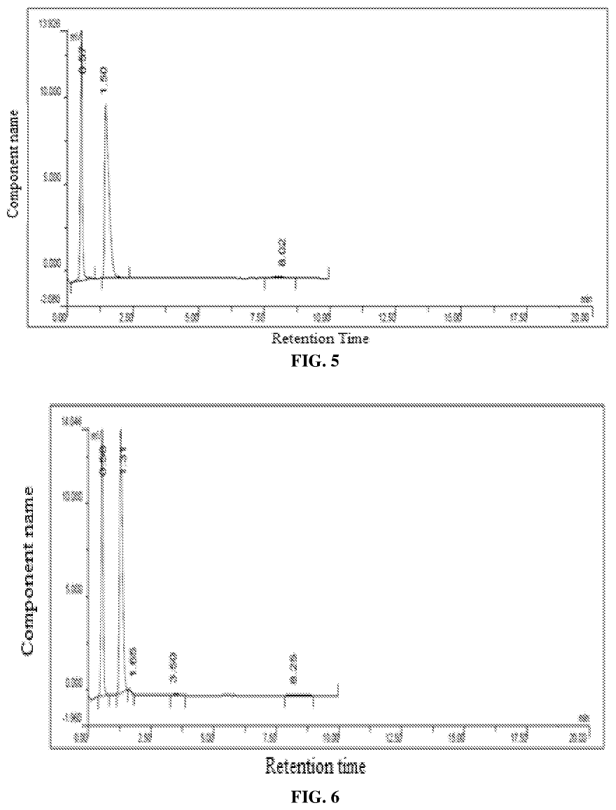

FIG. 5 illustrates an exemplary plot depicting gas chromatography results. It may be seen that H₂ (RT 0.57), CO (RT 1.50) and CO₂ (RT 8.02) are forming during this reaction, this confirms the presence of coke gasification and water gas shift reactions inside the apparatus [100]. The overall effect of these can be seen in considerable reduction in Coke formation which was collected after TOS 120 hrs and was measured 22 mg. It can be clearly observed that the rate of coke formation is reduced more than 3 times with the proposed approach and design. The table 1 further explains FIG. 5 graph with data points as below:

TABLE 1
Area % Height %

| S. | Component | Ret. | Area | Area | Height | Height |
|---|---|---|---|---|---|---|
| No. | Name | Time | μ Volt Sec | % | μ Volt | % |
| 1 | H₂ | 0.57 | 72781.8857 | 37.92 | 16177 | 61.52 |
| 2 | CO | 1.50 | 116176.4000 | 60.53 | 10040 | 38.18 |
| 3 | CO₂ | 8.02 | 2958.9143 | 1.54 | 80 | 0.30 |
| | | | 191917.2000 | 100.00 | 26297 | 100.00 |

FIG. 6 illustrates an exemplary plot depicting gas chromatography results. The plot shows the presence of H₂ (RT 0.5), CO (RT 1.65), CH₄ (RT 3.5) and CO₂ (RT 8.25) indicates the successful progress of coke gasification reaction. Total 15.3 mg/hr coke gasification rate was observed during the reaction. The table 2 further explains FIG. 6 graph with data points as below:

TABLE 2
Area % Height %

| | Component | Ret. | Area | Area | Height | Height |
|---|---|---|---|---|---|---|
| S. No. | Name | Time | μ Volt Sec | % | μ Volt | % |
| 1 | H₂ | 0.58 | 73468.6857 | 36.88 | 15302 | 51.19 |
| 2 | N₂ | 1.31 | 122215.0286 | 61.36 | 14360 | 48.04 |
| 3 | CO | 1.65 | 1092.0000 | 0.55 | 131 | 0.44 |
| 4 | CH₄ | 3.50 | 1385.7714 | 0.70 | 74 | 0.25 |
| 5 | CO₂ | 8.25 | 1023.7714 | 0.51 | 22 | 0.08 |
| | | | 199185.2571 | 100.00 | 29891 | 100.00 |

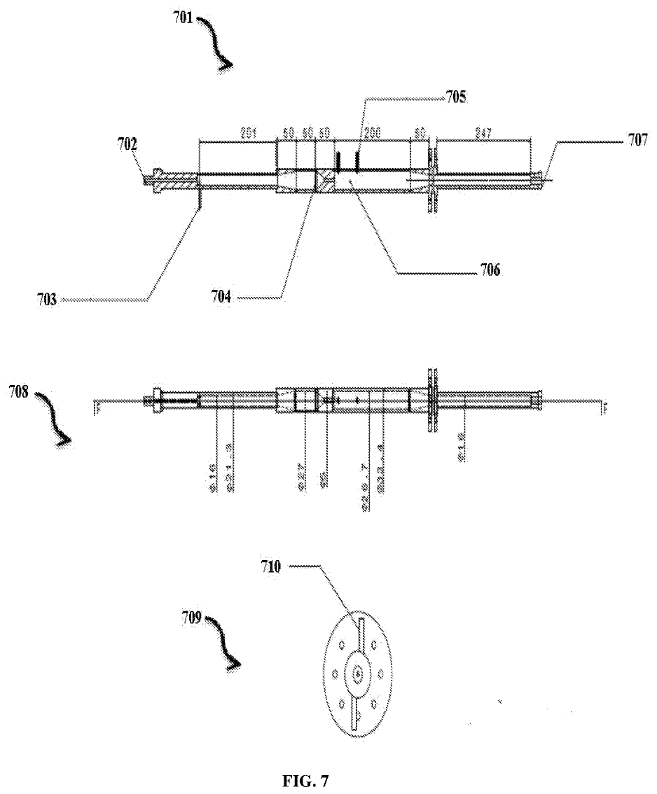

FIG. 7 illustrates a schematic representation of an apparatus [700] for production of syngas, according to another embodiment of the present disclosure. FIG. 7 further depicts special purpose apparatuses [701], [708] and [709] based on the design of the apparatus [100] of FIG. 1. Specifically, the apparatus [701] shows section view of the apparatus [100], [708] shows front view and [709] shows inside view of the apparatus [100]. More specifically, the apparatus 701 covers ⅛″ [702], thermowell, ¼″ tube for tangential inlet [703], catalyst support mesh with 1.5 mm pore size [704], ⅛″ water inlet [705], gasification zone [706], and ½″ water outlet [707]. Moreover, [701] show lengths of each section of apparatus such as 201 mm, 50 mm, 50 mm, 50 mm, 200 mm, 50 mm and 247 mm, e.g. the length from [703] to [704] is 301 mm (201+50+50). The same is applicable for rest of sections of apparatus [701].

The apparatus [708] show diameter of each sections of the apparatus such as 16 mm, 21.3 mm, 27 mm, 5 mm, 26.7 mm, 33.4 mm and 16 mm.

The apparatus [709] illustrates inside view of apparatus [700] showing tangential inlet [710].

It is noted that the apparatus may have variable length, diameter, size, number of swirlers (more than 2), number of catalyst beds (more than 2), number of zones (as mentioned above) depending upon production scale i.e., lab scale, industrial scale and so on, but it will still show the effective and improved effects as provided above.

The apparatus [700] includes a high-velocity spinning flow zone, a dry reforming zone, a high-velocity zone, a coke gasification zone, and a WSG zone. In the high-velocity spinning flow zone, mixing occurs, along with heat and mass transfer, leading to furthering the reaction.

In the dry reforming zone, required superficial flow velocity for the gases is provided. Further, the apparatus [700] helps to maintain a required back pressure inside the apparatus [700] to avoid channeling. Furthermore, catalyst extrudes are placed on a screen of mesh size of about 2 mm.

In the high-velocity zone, a conical bed is fabricated after the catalytic bed in order to maintain high fluid flow velocity, which helps to create the desired back pressure in the catalyst bed and avoid channeling. Further, such high velocity region also creates a low-pressure zone near a tip of the conical section, which assists in water—gas mixing and carbon gasification.

In the coke gasification zone, water is used for gasification. The water inlet flows and temperatures are maintained in such a way that heat is quenched and gasification of coke occurs. This will help to reduce coke formation during the reaction, and thus, improves the reaction throughput.

In the WSG zone, the unreacted water from the coke gasification zone is further used for water-gas shift reaction in the same apparatus [700]. The water-gas shift reaction maintains the desired quality of the syngas i.e., H₂:CO.

A 5 ml catalyst was loaded in the apparatus [700] and heating was started with a ramp rate of 10° C./min till temperature reached to 850° C. Once reactor temperature reached 850° C., CO₂ and CH₄ flow (250 ml/min each) was stared inside the apparatus [700] and water was injected with a flow rate of 0.2 ml/min inside the apparatus [700] through water entry provided 50 mm below the catalyst bed. The reaction was performed for 300 h. The outlet gas was measured and analysed. A steady state conversion of 90-95% of CH₄ and CO₂ was observed. The optimum H₂:CO ratio of 1-1.5 was obtained which can be easily tuned as per the process requirements. No coke formation was observed due to Boudouard reaction throughout this duration.

The present invention provides good heat transfer using above mentioned design approach.

The present invention allows carbon formation inside the reactor to be reduced by 3.3 times.

The present invention allows carbon gasification rate to be more than carbon formation rate.

The present invention provides an apparatus that can be used for various reforming reactions to improve the process yield, to avoid the pressure build up due to coke formation. DRM reaction activity of above 92% CH₄ conversion and above 95% of CO₂ conversion can be achieved.

The catalyst used in said 1^{st} and 2^{nd} catalyst beds [102, 105] is any reforming catalyst that is used in the art and known to a person skilled in the art. Some of examples of said reforming catalysts are covered in the patent application IN201713014438, IN201611044559 and JP 2012-533512 A.

The method of present invention disclosed herein is a continuous process of production of H₂ and CO gases along with reduction of coke.

The overall run time of the apparatus and method disclosed herein is up to 350 hours or more. Since this is a continuous reaction, time is can be more than 350 hours depending upon demand of CO and H₂, and supply of reactants (CH₄ & CO₂), and catalysts. Time on Stream is important only to substantiate the stability of the catalyst, however, the catalyst per se is not claimed herein.

The present invention allows desired H₂:CO ration can be maintained using this design as it offers in-situ water gas shift and Coke gasification zones as shown in design.

The apparatus disclosed herein provides better H₂ and CO formation and CH₄ reformation with better yield, heat transfer and lesser coke production thereby increasing stability of catalysts The temperature kept in the apparatus and processes disclosed herein is different/varying depending upon zones as mentioned above, which may include but not limited to in the range of 250-1000° C.

The apparatus disclosed herein is useful in various reforming reactions such as but not limited to dry reformation of methane (DRM), SRM (steam reforming of methane), OSRM (oxidative steam reforming of methane), methanol reforming, ethanol reforming, and so on.

The apparatus disclosed herein is made of dimensions (of any length, breadth, height, diameter, circumference, etc.) suitable for lab scale and industrial scale, which a person having ordinary skill in the art can easily contemplate having common knowledge of the art.

The apparatus disclosed herein is made of dimensions suitable for 0.1 cc to 1000 kg loading of catalyst and reforming reactions.

The apparatus disclosed herein is made of dimensions suitable for 1 cc to 3 cc catalyst loading and reforming reactions.

The apparatus disclosed herein may be considered as single tube reactor, and the present invention may include such plurality of tube reactors in a single furnace or in plurality of furnaces to conduct the reforming and other related reactions.

### EXAMPLES

Following examples are given by way of illustration and therefore should not be construed to limit the scope of the invention.

### Example 1

An apparatus (MOC SS316) [100, FIG. 1] with 20 mm OD and 10 mm ID was used for the reaction “coke formation by Boudouard reaction”. Pure CO gas with purity of 99% was procured from Effectech gases. Initially the apparatus was heated with ramp rate of 10 degrees per minute from room temperature [25° C.] to 800° C. Then CO gas with the flow rate of 400 ml/m was sent through mass flow controllers inside the hollow reactor tube at 800° C. for 120 hrs the reactor temperature was controlled using PID controllers. The outlet gas flow was measured further. The total formed carbon inside the reactor was collected after TOS 120 and it was measured, total 74 mg carbon collected.

### Example 2

An apparatus (MOC SS316) [100, FIG. 1] with 20 mm OD and 10 mm ID was used for the reaction “Water Gas Shift reaction”. Pure CO gas with purity of 99% was procured from Effectech gases. Initially the reactor was heated with ramp rate of 10 degrees per minute from room temperature to 800° C. Then CO gas with the flow rate of 400 ml/m was sent through mass flow controllers inside the hollow reactor tube at 800° C. for 120 hrs. The reactor temperature was controlled using PID controllers. Along with CO gas, water also injected inside the reactor with flow rate of 0.4 ml/min which corresponds to the molar ratio of 1.2 (H2O:CO). The outlet gas flow was measured further and analysed using gas chromatography.

### Example 3

An apparatus (MOC SS316) [100, FIG. 1] with 20 mm OD and 10 mm ID was used for the reaction “coke gasification”. The Coke formed during the Dry reforming of methane reactions was collected and used as a reactant. De-ionised water with conductivity of 0.049 Micro Siemens/cm was generated using Millipore equipment. 1.3 gm Coke was loaded in the apparatus and reactor heating started with the ramp rate of 10 degree/min till temperature reaches to 700° C. under the purge flow of N2 gas with the flow rate of 30 ml/min. Once reactor temperature reaches 800° C. the water was injected with the flow rate of 2.6 ml/hr inside the reactor. The reaction was done for 7 hrs. The outlet gas was measured and analysed. The carbon quantity after the reaction was measured.

### Example 4

A reactor was fabricated (MOC SS316) [100, FIG. 1] as schematically represented in FIG. 7 and as per the design shown in FIG. 1 and used for syngas generation by dry reforming of methane. The reactor is equipped with four different reaction zones which are as follows:
1. High velocity spinning flow zone (ID-16 mm, length 201 mm), this zone helps for the mixing, heat transfer and mass transfer which further help the reaction.
2. Dry Reforming zone (ID-27 mm, length 50 mm) this zone offers the required superficial flow velocity for the gases also the reactor internals helps to maintain required back pressure inside the reactor to avoid channeling, the catalyst extrudes were placed on a SS-316 screen of mesh size 2 mm.
3. High velocity zone: After the catalytic bed, a conical outlet was fabricated (conical section ID at in gas entry 27 mm, cone length 50 mm, ID at the gas exit 5 mm) in order to maintain high fluid flow velocity which will help to create desired back pressure in the catalyst bed and avoid channeling. Apart from this, such high velocity region will also create low pressure zone near the tip of the conical section which will helpful for water—gas mixing and carbon gasification.
4. Coke gasification zone: A separate Coke gasification zone (ID-26.7 mm, length 250 mm) was provided where water is used for carbon gasification. The water inlet flows and temperatures are maintained in such a way that heat will also be quenched and gasification of coke also can be achieved. This will help to reduce coke formation during the reaction and thus improves the reaction throughput.
5. WGS zone: The unreacted water from gasification zone (ID-16 mm, length 247 mm) is further used for water gas shift reaction in the same reactor. The water gas shift reaction will help to maintain the desired quality of syngas i.e., H₂:CO from the reactor outlet.

5 ml catalyst was loaded in the apparatus and reactor heating started with the ramp rate of 10° C./min till temperature reaches to 850° C. Once reactor temperature reaches 850° C., CO₂ and CH₄ flow (250 ml/min each) was stared inside the reactor and water was injected with flow rate of 0.2 ml/min inside the reactor through water entry provided at 50 mm below catalyst bed. The reaction was done for 300 h. The outlet gas was measured and analysed. The steady state conversion of 90-95% of CH₄ and CO₂ was observed. The optimum H₂:CO ratio of 1-1.5 was obtained. No Coke formation was observed due to Boudouard reaction throughout this duration.

### Advantages of the Invention

The present invention provides an apparatus for production of syngas.
The present invention provides an apparatus that reduces carbon formation during dry reformation of methane.
The present invention provides an apparatus for production of syngas that increases the operating life of catalyst.
The present invention provides an apparatus with improved operational parameters for efficient production of syngas.

1. An apparatus for reforming of methane (RM) comprising:
i. a reforming zone;
ii. a high velocity zone;
iii. a coke gasification zone;
iv. a water gas shift (WGS) zone; and
v. one or more spinning flow guider(s) or swirler(s).

2. The apparatus as claimed in claim 1, wherein
i. the reforming zone being an upper part of the apparatus comprises: i) a first catalyst bed, and ii) tangential inlet pipes for methane gas and CO2 gas;
ii. the high velocity zone comprises a nozzle shaped device for increasing back pressure and good heat transfer;
iii. the coke gasification zone comprises inlet for water to react with coke, carbon or graphite;
iv. the WGS zone comprises: i) a second catalyst bed, and ii) unreacted water; and
v. the one or more spinning flow guider or swirlers is/are disposed above the first catalyst bed in the reforming zone and below the coke gasification zone for turbulent mixing, achieving heat distribution and heat transfer, and reducing coke formation in overall reactor.

3. The apparatus as claimed in claim 1, wherein the nozzle shaped device of the high velocity zone is fabricated after the catalytic bed in order to maintain high fluid flow velocity, which helps to create the desired back pressure in the catalyst bed and avoid channeling.

4. The apparatus as claimed in claim 1, wherein the high velocity zone creates a low-pressure zone near a tip of the nozzle shaped device [114, FIG. 1], which assists in water—gas mixing and carbon gasification.

5. The apparatus as claimed in claim 1, wherein in the WSG zone, the unreacted water from the coke gasification zone is used for water-gas shift reaction, maintaining the desired syngas production as in H2:CO gases mixture.

6. A method of production of syngas 5 by reforming of methane (RM) comprising the steps of:
a) passing a methane gas and CO2 gas from tangential inlet pipes placed in the reforming zone being an upper part of the apparatus as claimed in claim 1, through spinning flow guider(s) or swirler(s) to have better turbulent mixing to the catalyst bed of the reforming zone to obtain syngas (CO+H2);
b) passing the syngas of step a) through conical/nozzle shaped device of the high velocity zone with turbulent flow where a flow velocity increases, pressure decreases and better mixing with water from water inlet;
c) passing the mixture of syngas, and other unreacted gases of step b) through coke gasification zone where the coke/carbon deposits is reduced by reacting with water thereby gasifying the coke; and
d) passing an unreacted water in the WGS zone in order to obtain H2 and CO gases.

7. The method as claimed in claim 6, wherein the step a) comprises:
i. before passing of the methane gas and CO2 gas in the apparatus, the reforming zone is heated with a ramp rate of 10° C./min till temperature reached to 850° C.; and
ii. after passing the methane gas and CO2 gas in the apparatus, water is injected with a flow rate of 0.1 to 1 ml/min through water entry provided below the first catalyst bed where reaction of the methane gas and CO2 gas in presence of said first catalyst bed (102) is performed at temperature in the range of 700-1000° C. to obtain H2 and CO as outlet gases.

8. The method as claimed in claim 6, wherein conversion of CH4 and CO2 into CO and H2 is in the range of 90-95%; and yield ratio of H2:CO ratio is in the range of 1-1.5.

9. The method as claimed in claim 6, wherein temperature of the steps b), c) and d) is in the range of 250-1000° C.

10. The apparatus as claimed in claim 1, and the process as claimed in claim 6, wherein the reforming of methane is selected from the group consisting of dry reforming of methane (DRM), steam reforming of methane (SRM), oxidative steam reforming of methane (OSRM), and methanol reforming and ethanol reforming.
